(19) United States
(12) Patent Application Publication
(10) Pub. No.: US 2006/0222822 A1
(43) Pub. Date: Oct. 5, 2006

(54) Composite sign panel

(76) Inventor: Dennis Bringuet, Springfield, IL (US)

Correspondence Address: DONALD G. FLAYNIK, JR.;CHERSKOV AND FLAYNIK, SUITE 1447, 20 NORTH WACKER DR., CHICAGO, IL, 60606, US

(21) Appl. No.: 11/093,588

(22) Filed: Mar. 30, 2005

(51) Int. Cl. B32B 3/20

(52) U.S. Cl. 428/188; 428/166

(57) ABSTRACT

A composite sign panel 10 includes an inner sheet 12 fabricated from a transparent, fluted material capable of supporting a predetermined sign display, an outer sheet 14 fabricated from a protective material capable of maintaining the transparency of the inner sheet 12 irrespective of intensity and exposure time to sunlight upon the outer sheet 14, and an adhesive means such as a solvent glue for securing the inner sheet 12 to the outer sheet 14.

### BACKGROUND OF THE INVENTION

1. Field of the Invention

The present invention relates to sign panels and more particularly, to composite sign panels having an inner transparent sheet for supporting a sign display, and an outer opaque sheet for preventing the inner sheet from turning yellow due to sunlight exposure.

2. Background of the Prior Art

Outdoor sign displays are visible at virtually every business open to customers. Generally, the outdoor signs are constructed of a sign structure or framework fabricated from angle iron, sheet metal and a mounting pole. The sign structure is configured to correspond to and support the periphery of a sign panel which in turn supports a preselected sign display. The interior of the sign structure includes a light source that uniformly illuminates the sign panel which correspondingly illuminates the sign display. The material used to fabricate the sign panel is generally plastic that is sufficiently “strong” to support the sign display and to withstand inclement weather. Further, the sign panel material is generally opaque or “milky white” in color to obscure or “hide” the outline of the light source inside the sign structure.

The problem with prior art sign panels is that overtime, sunlight causes relatively strong, opaque plastic materials to yellow thereby diminishing illumination and appearance of the sign display. Alternative plastics that resist yellowing when exposed to sunlight, are fragile and break relatively easy when exposed to high but routine wind velocities. An example typical of prior sign panels is disclosed in U.S. Pat. No. 6,224,706, which includes the materials of fabrication, configurations and problems as detailed above.

A need exists for a sign panel that is strong and capable of supporting a myriad of sign displays, durable and capable of withstanding high wind velocities, and resistive to sunlight thereby maintaining sign panel color and correspondingly maintaining sign display illumination and appearance.

### SUMMARY OF THE INVENTION

It is an object of the present invention to overcome may of the disadvantages associated with composite sign panels that support and promote illumination of sign displays.

A principle object of the present invention is to provide a sign panel that supports and illuminates a sign display secured to thereto. A feature of the sign panel is a first inner polycarbonate sheet that includes a plurality of parallel flutes extending therethrough. Another feature of the sign panel is a second inner acrylic sheet that is opaque. An advantage of the sign panel is that the support capability of the inner sheet is adjusted by the quantity of flutes per unit length of sign panel. Another advantage of the sign panel is that the milky white acrylic sheet will not turn yellow when exposed to sunlight.

Another object of the present invention is to provide a sign panel that uniformly illuminates the sign display. A feature of the sign panel is a clear polycarbonate first inner sheet. Another feature is of the sign panel is a milky white second inner sheet. An advantage of the sign panel is that light generated inside a sign structure penetrates the first inner sheet. Another advantage of the sign panel is that the internally generated light is uniformly disbursed throughout the second inner sheet thereby providing an uniformly illuminated sign display without the contours of the internal lights being seen.

Still another object of the present invention is to provide a sign panel that requires minimal assembly components. A feature of the sign panel is the inner and outer sheets being secured together with glue. An advantage of the sign panel is that the inner and outer sheets are quickly and inexpensively secured together.

Yet another object of the present invention is to provide a sign panel that maintains the clarity of the fluted polycarbonate inner sheet. A feature of the sign panel is the sealing of an edge portion of the inner sheet flutes with a tape material. An advantage of the sign panel is that foreign objects including insects and dust do not enter the inner sheet.

Another object of the present invention is to provide a sign panel capable of supporting relatively heavy sign displays. A feature of the sign panel is disposing the flutes of the inner sheet in horizontal, vertical or angular orientations. Another feature of the sign panel is to provide an inner sheet with two layers of polycarbonate, the two layers being disposed such that the flutes of the first layer are perpendicular to the flutes of the second layer when taking a front elevation view of the sign panel. An advantage of the sign panel is that the orientation and configuration of the inner sheet may be economically varied to provide the quantity of material strength required to support a predetermined sign display.

Briefly, the invention provides a composite sign panel comprising an inner sheet of transparent material capable of supporting a predetermined sign display; an outer sheet of protective material that maintains the transparency of said inner sheet irrespective of sunlight intensity upon said outer sheet; and means for securing said inner sheet to said outer sheet.

The invention further provides a method for fabricating an outdoor sign panel that maintains transparency irrespective of exposure to sunlight, said method comprising the steps of providing an inner sheet fabricated from transparent material; providing an outer sheet fabricated from opaque material; and securing said inner and outer sheets together.

The invention further provides a method for fabricating a sign panel for an existing sign structure, said method comprising the steps of providing an inner sheet fabricated from first and second layers transparent, fluted material, said fluted first layer being secured to said fluted second layer such that flutes of said first layer are oriented perpendicularly to flutes of said second layer when taking a front view of said inner sheet; providing an outer sheet fabricated from opaque material; securing said inner and outer sheets together; and modifying the existing sign structure such that said sign panel is detachably joined to a modified frame portion of the existing sign structure after removing an existing sign panel from said existing sign structure.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a front perspective view of a composite sign panel in accordance with the present invention.

FIG. 2 is an exploded view of FIG. 1 wherein separated sheets comprising the composite sign panel are depicted.

FIG. 3 is a top elevation view of the composite sign panel of FIG. 1.

FIG. 4 is a side elevation view of the composite sign panel of FIG. 1.

FIG. 5 is a front perspective view of a composite sign panel depicting an inner sheet with two layers in accordance with the present invention.

FIG. 6 is an exploded view of FIG. 6 wherein separated layers of an inner sheet and a separated outer sheet comprising the composite sign panel are depicted.

FIG. 7 is a top elevation view of the composite sign panel of FIG. 5.

FIG. 8 is a side elevation view of the composite sign panel of FIG. 5.

FIG. 9 is a front perspective view of a sign structure having a composite sign panel attached thereto, the composite sign panel supporting a sign display in accordance with the present invention.

FIG. 10 is an exploded view of FIG. 9 in accordance with the present invention.

### DESCRIPTION OF THE PREFERRED EMBODIMENT

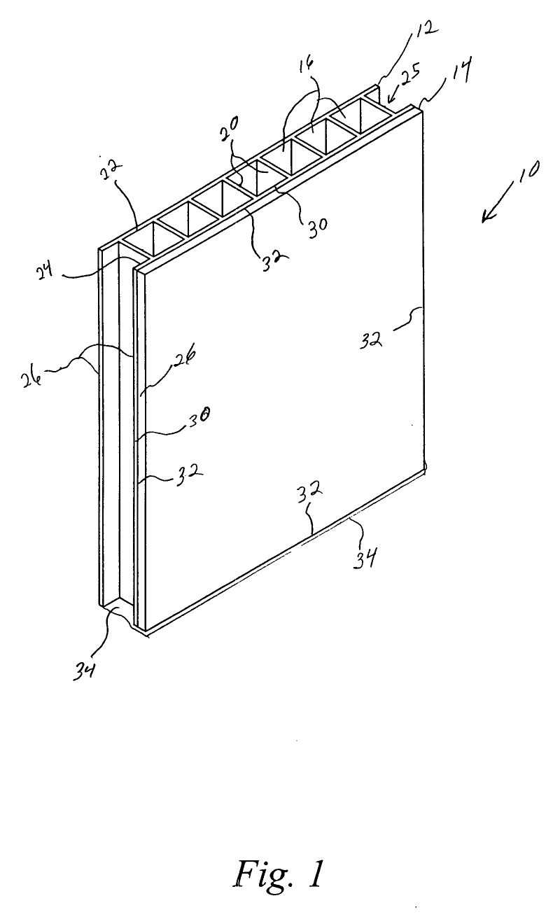

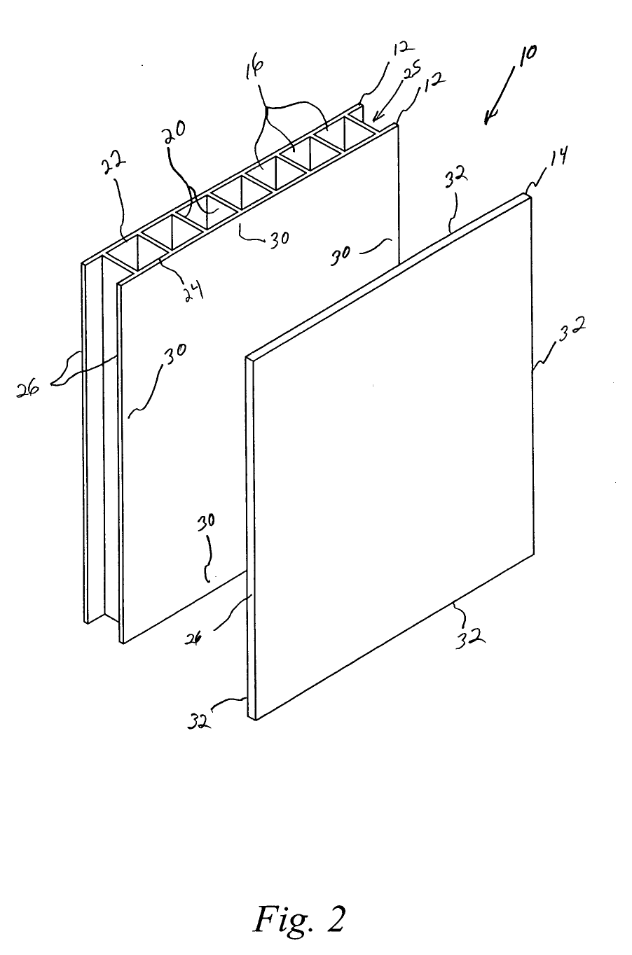

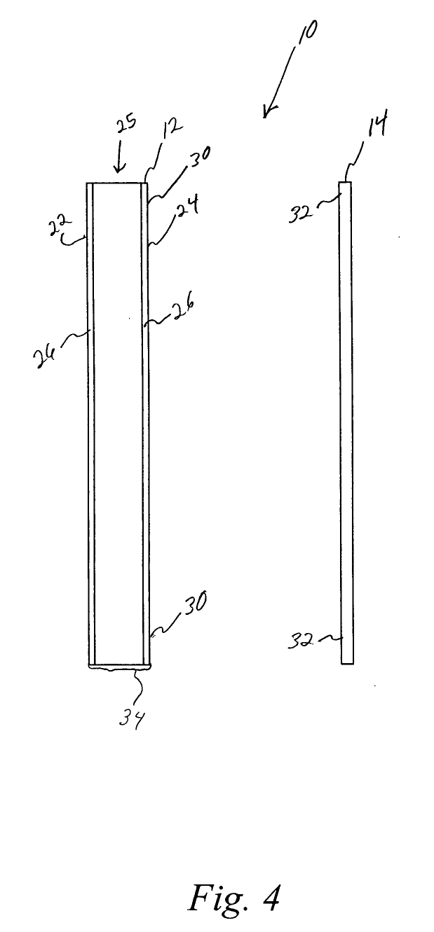

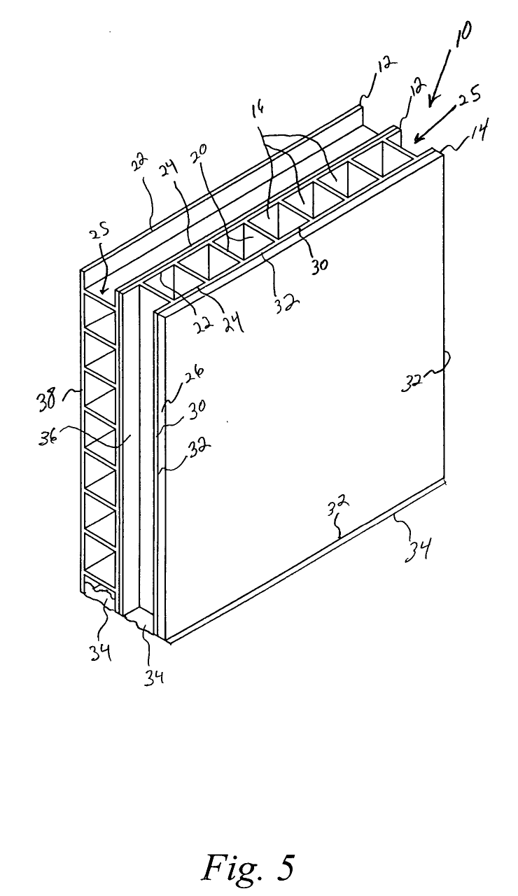

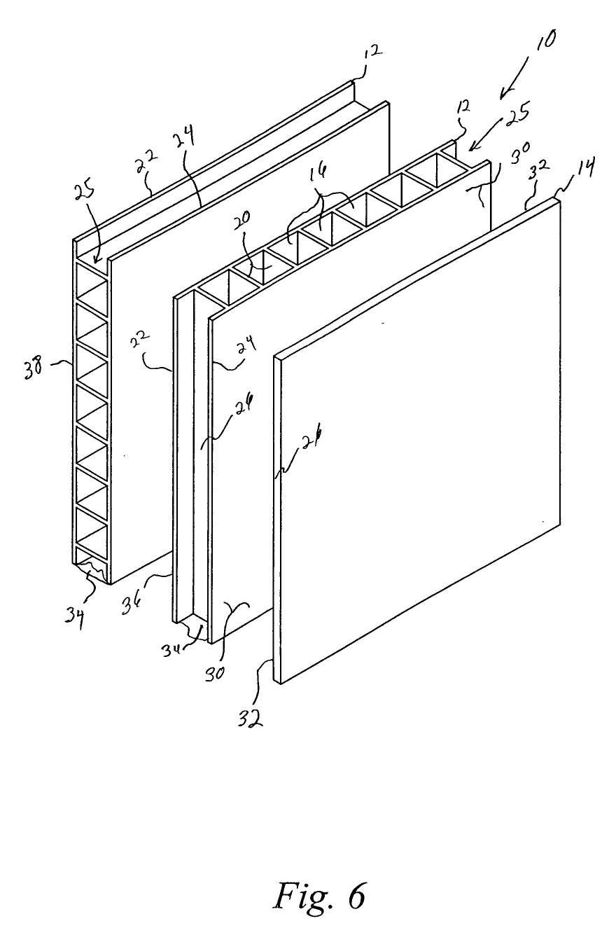

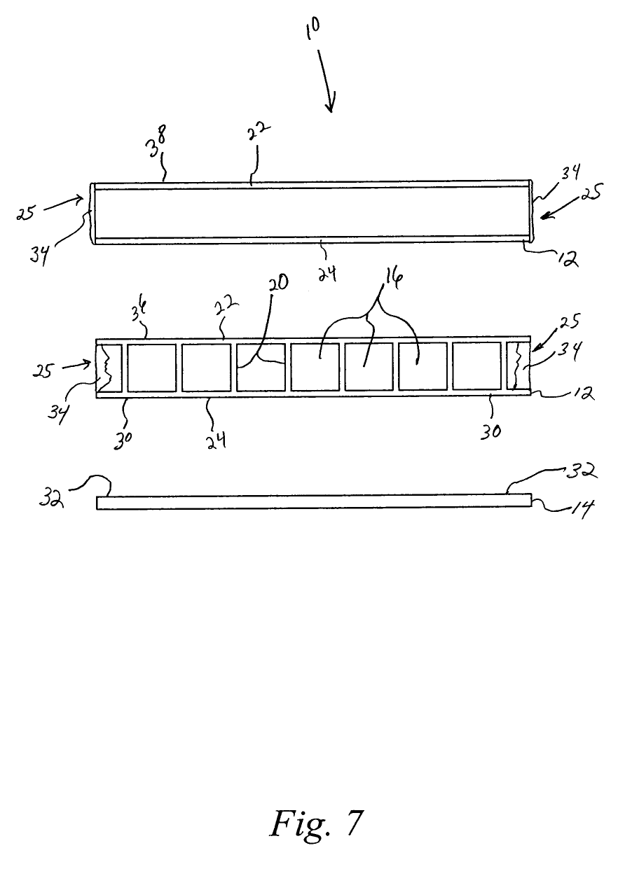

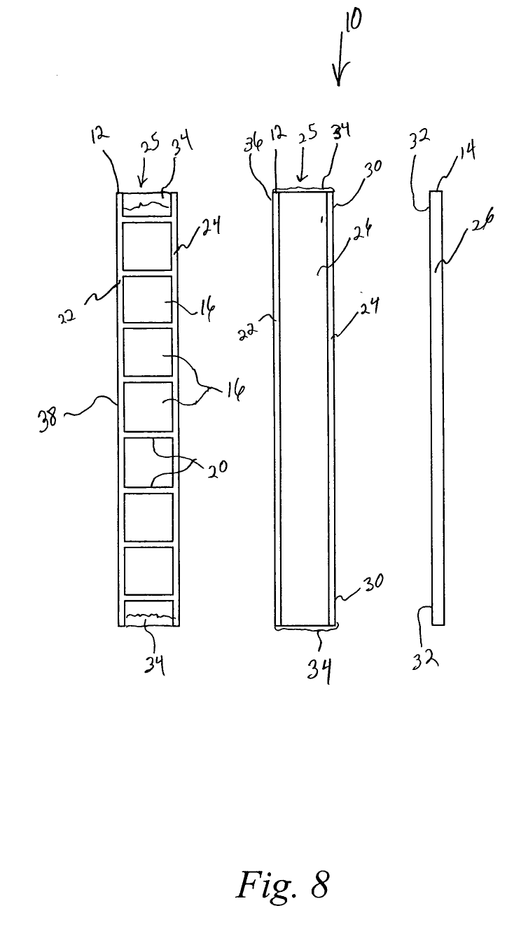

Referring now to the drawings, and in particular to FIGS. 1-8, a composite sign panel in accordance with the present invention is denoted as numeral 10. The sign panel 10 includes an inner sheet 12 fabricated from a transparent material capable of supporting a predetermined sign display (not part of the present invention), an outer sheet 14 fabricated from a protective material capable of maintaining the transparency of the inner sheet 12 irrespective of intensity and exposure time to sunlight upon the outer sheet 14, and an adhesive means such as a solvent glue for securing the inner sheet 12 to the outer sheet 14.

The preferred transparent support material for the inner sheet 12 is a clear polycarbonate having a plurality of flutes 16. Relative to prior art materials, the polycarbonate material is lightweight, can be cut with simple tools such as a knife, resists turning yellow, difficult to break, more rigid and more supportive but dimensionally thinner, less expensive and allows more light generated inside a sign structure 18 to pass through the inner sheet 12.

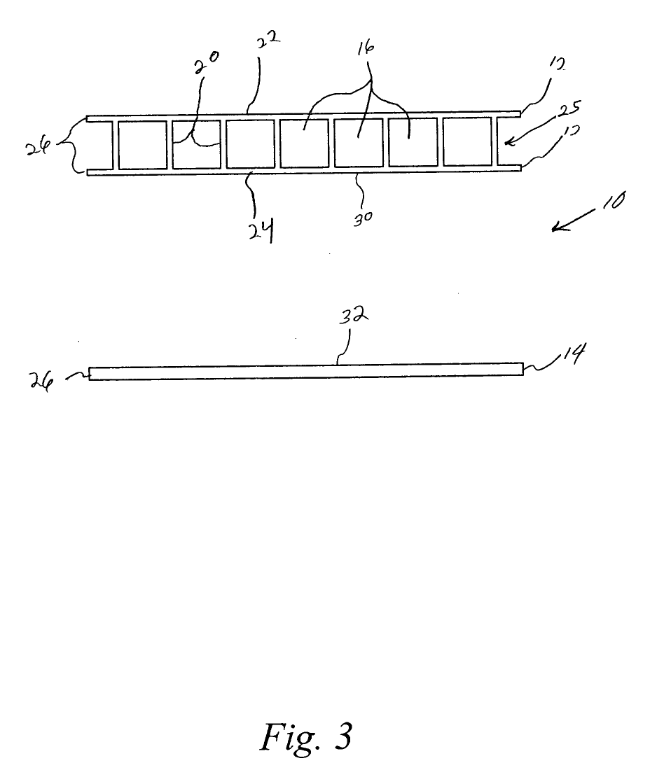

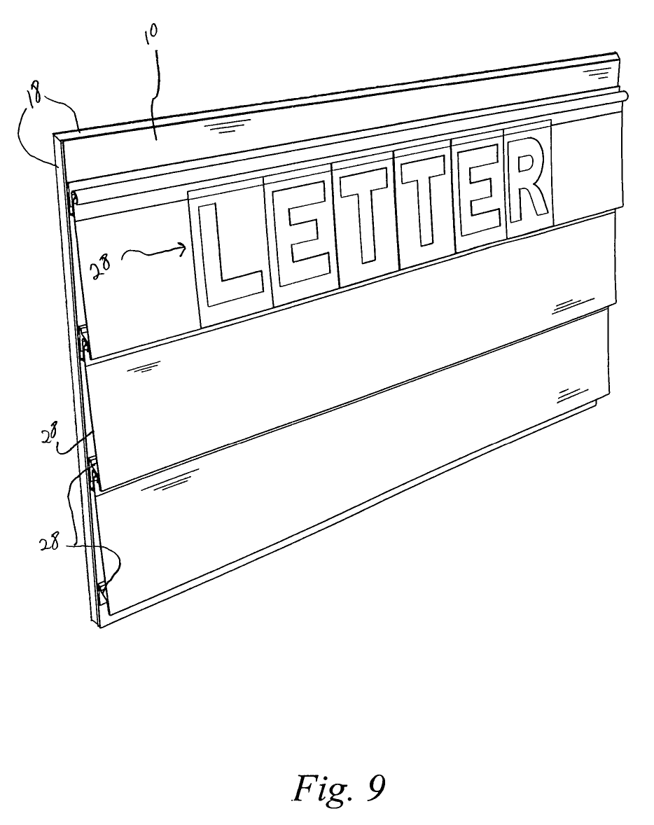

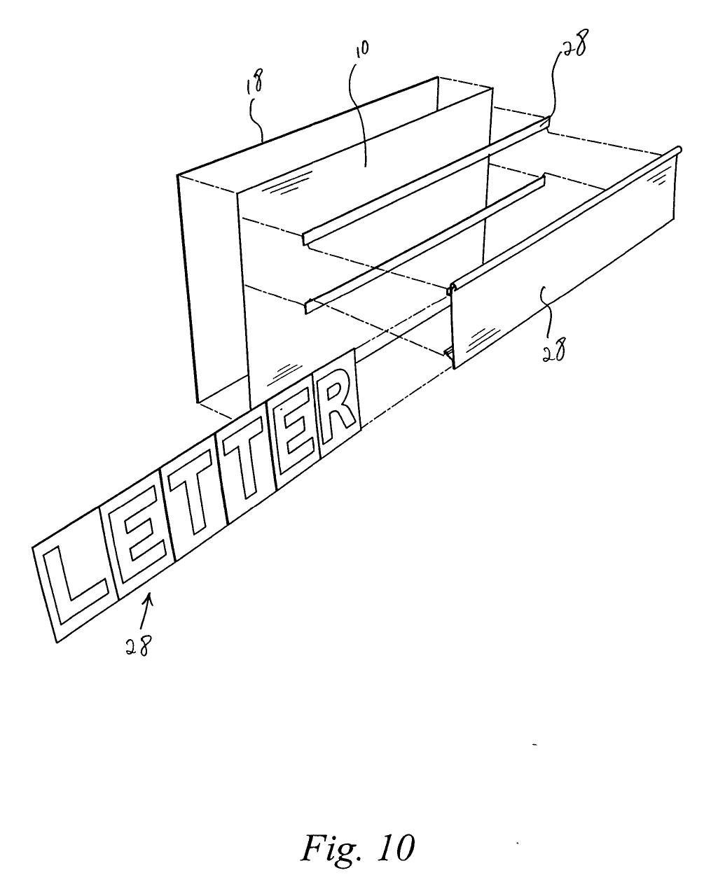

The flutes 16 of the inner sheet 12 are formed by disposing rectangularly configured, relatively “thin,” planar, polycarbonate separator members 20 between first and second, planar, polycarbonate wall members 22 and 24. The separator members 20 are parallel to each other and perpendicularly joined to the first and second wall members 22 and 24 such that the separator members 20 are spaced apart substantially about one-quarter of an inch. The lateral dimension of the separator members 20 is substantially about one-eighth of an inch thereby providing a plurality or row 25 of longitudinally aligned rectangular flutes 16 or apertures when taking top or bottom elevation views of the inner sheet 12 (see FIG. 3). The longitudinal dimension of the separator members 20 determines a first side 26 length of the joined first and second wall members 22 and 24. The configuration and dimensions of the inner sheet facilitate the support (via methods well known to those of ordinary skill in the art) of a typical plastic sign display 28 as depicted in FIGS. 9 and 10. In the event that the sign display 28 is larger and heavier than the typical sign display, a larger quantity of flutes 16 may be included in the inner sheet 12 to correspondingly increase the support capability and rigidity of the inner sheet 12. A smaller and lighter weight sign display 28 would require fewer flutes 16 between the first and second wall members 22 and 24.

The preferred protective material for the outer sheet 14 is an opaque acrylic plastic substantially about one-sixteenth inch thick. The outer sheet includes a substantially “milky” white color that will not turn yellow from exposure to sunlight, and that prevents the contour of the lights that illuminate the sign display 28 from being seen thereby uniformly illuminating the sign display 28. The outer sheet 14 is secured to the inner sheet 12 by applying a #40 solvent glue upon engaging peripheral portions 30 and 32 of the inner and outer sheets 12 and 14.

The rectangular flutes 16 inner sheet 12 ultimately accumulates insects and dirt via the rows 25 of apertures resulting in the reduction of illumination of the sign display 28. To maintain a clean and clear inner sheet 12, a sealing means such as a duct tape material 34 is disposed upon opposite rows 25 of apertures of the inner sheet 12 after the inner and outer sheets 12 and 14 have been glued together.

The inner sheets 12 of polycarbonate are manufactured by methods that produce varying sizes of inner sheets 12 which include four by eight feet, six by twelve feet, six by ten feet and seven by twenty-four feet sections with flutes 16 longitudinally disposed along the greater dimension. Sign displays 28 are generally orientated such that their longitudinal dimensions are horizontal and their lateral dimension is vertical. The general orientation results in the flutes 16 being horizontally disposed when a sign display 28 having a horizontal dimension greater than four feet is constructed. Relatively heavy sign displays 28 require the longitudinal sides of the flutes 16 to be vertically orientated to support the various members forming the sign display 28. Alternatively, the flutes 16 may be orientated such that the longitudinal sides of the flutes 16 are disposed at an acute angle relative to a horizontal axis of the sign display 28. The inner sheets 12 are readily fabricated by cutting portions of sufficiently large inner sheets 12 with ordinary hand tools.

Some sign displays 28 include elements that are exceptionally heavy thereby requiring a composite sign panel 10 with increased sign display support capability. One method of increasing the support capability of the composite sign panel 10 is to increase the quantity of fluted polycarbonate layers that form the inner sheet 12. A first sheet 36 or layer of fluted polycarbonate orientated such that the longitudinal axes of the flutes 16 of the first sheet 36 are vertically disposed, is secured via solvent glue to a second sheet 38 of fluted polycarbonate orientated such that the longitudinal axes of the flutes 16 of the second sheet 38 are horizontally disposed when taking a front elevation view of the sign display 28. Alternatively, the longitudinal axes of the flutes 16 of the first sheet 36 may be angularly orientated to a horizontal axis of the sign display 28, and the longitudinal axes of the flutes 16 of the second sheet 38 are orientated perpendicularly to the flutes 16 of the first sheet 36 when taking a front elevation view of the sign display 28. Thus, the orientation and configuration of the inner sheet 12 of the composite sign panel 10 may be varied to provide the quantity of polycarbonate strength required to support the sign display 28.

A composite sign panel 10 comprised of first and second polycarbonate sheets 36 and 38 generally will be to thick to be attached to an existing sign structure 18. The thicker composite sign panel 10 is attached to the existing sign structure 18 by modifying the existing sign structure 18 to detachably join (via methods well known to those of ordinary skill in the art) the composite sign panel to a modified frame portion of the existing sign structure after removing an existing sign panel from the existing sign structure.

The foregoing description is for purposes of illustration only and is not intended to limit the scope of protection accorded this invention. The scope of protection is to be measured by the following claims, which should be interpreted as broadly as the inventive contribution permits.

1. A composite sign panel comprising:
an inner sheet of transparent material capable of supporting a predetermined sign display;
an outer sheet of protective material that maintains the transparency of said inner sheet irrespective of sunlight intensity upon said outer sheet; and
means for securing said inner sheet to said outer sheet.

2. The sign panel of claim 1 wherein said inner sheet is fabricated from a polycarbonate material.

3. The sign panel of claim 1 wherein said inner sheet includes a fluted material.

4. The sign panel of claim 1 wherein said inner sheet is fabricated from a fluted polycarbonate material.

5. The sign panel of claim 1 wherein said outer sheet is fabricated from a translucent material.

6. The sign panel of claim 1 wherein said outer sheet is fabricated from an opaque material.

7. The sign panel of claim 5 wherein said translucent material includes an acrylic material.

8. The sign panel of claim 1 wherein said securing means includes a solvent glue.

9. The sign panel of claim 3 wherein an edge portion said fluted material is covered with a sealing means for preventing foreign objects from entering therein.

10. The sign panel of claim 9 wherein said sealing means includes a tape material.

11. The sign panel of claim 3 wherein said fluted material is orientated such that said flutes are angularly disposed..

12. The sign panel of claim 3 wherein said fluted material is orientated such that said flutes are vertically disposed.

13. The sign panel of claim 3 wherein said fluted material is orientated such that said flutes are horizontally disposed.

14. The sign panel of claim 3 wherein said inner sheet includes a first layer of vertically orientated fluted material and a second layer of horizontally orientated fluted material.

15. The sign panel of claim 3 wherein said fluted material is orientated such that said flutes are disposed at an acute angle relative to a horizontal axis of said sign display.

16. The sign panel of claim 3 wherein said inner sheet includes a first layer of angularly orientated fluted material and a second layer of fluted material orientated such that said flutes of said second layer are perpendicular to said flutes of said first layer.

17. The sign panel of claim 1 wherein said inner sheet is relatively thicker than said outer sheet.

18. A method for fabricating an outdoor sign panel that maintains transparency irrespective of exposure to sunlight, said method comprising the steps of:
providing an inner sheet fabricated from transparent material;
providing an outer sheet fabricated from opaque material; and
securing said inner and outer sheets together.

19. The method of claim 18 wherein said step of providing an inner sheet includes the step of fabricating said transparent material from a fluted material.

20. A method for fabricating a sign panel for an existing sign structure, said method comprising the steps of:
providing an inner sheet fabricated from first and second layers of transparent, fluted material, said fluted first layer being secured to said fluted second layer such that flutes of said first layer are oriented perpendicularly to flutes of said second layer when taking a front view of said inner sheet;
providing an outer sheet fabricated from opaque material;
securing said inner and outer sheets together; and
modifying the existing sign structure such that said sign panel is detachably joined to a modified frame portion of the existing sign structure after removing an existing sign panel from said existing sign structure.
